(19) United States
(12) Patent Application Publication
(10) Pub. No.: US 2003/0023607 A1
(43) Pub. Date: Jan. 30, 2003

(54) Method and system for processing queries requiring coordinated access to distributed databases

(76) Inventors: Timothy Phelan, New York, NY (US); Christine Smyth-Boyce, Long Beach, NY (US)

Correspondence Address: CLIFFORD CHANCE US LLP, 200 PARK AVENUE, NEW YORK, NY, 10166, US

(21) Appl. No.: 10/112,208

(22) Filed: Mar. 29, 2002

Related U.S. Application Data
(60) Provisional application No. 60/280,365, filed on Mar. 30, 2001.

(51) Int. Cl. G06F 7/00; G06F 17/00; G06F 17/30

(52) U.S. Cl. 707/100; 707/3; 707/104.1

(57) ABSTRACT

A method and system for coordinating customer access to a distributed database system, such as a financial services system database pool containing various sources of different types of data, receives as input a user query, such as a query related to the status of financial transactions. The query is processed to determine the types of data required to satisfy the query and the target data sources containing such data. Discrete sub-queries are formulated and issued to the identified target data sources. The retrieved data is combined to generate a response to the query which is formatted and returned to the requestor, preferably in the form of an Internet web page.

### CROSS-REFERENCE TO RELATED APPLICATIONS

This application claims priority under 35 U.S.C. §119 to U.S. Provisional Application Serial No. 60/280,365, filed on Mar. 30, 2001 and entitled “Method and System for Coordinating Customer Access to Distributed Financial Services Databases”, the entire contents of which is hereby expressly incorporated by reference.

### COPYRIGHT STATEMENT

This document contains material which is subject to copyright protection. The applicant has no objection to the reproduction of this patent document, as it appears in the U.S. Patent and Trademark Office patent file or records or in any publication by the U.S. Patent and Trademark Office or counterpart foreign or international instrumentalities. All remaining copyright rights whatsoever are otherwise reserved.

### FIELD OF THE INVENTION

This invention is related to the field of data query processing system. More particularly, this invention is related to a method and system for processing queries which require access to a plurality of different data sources to satisfy.

### BACKGROUND

Electronic trading of financial securities, currencies, and other financial instruments is widely practiced. In order for an investor to trade electronically, the investor typically must register with a suitable on-line broker or other financial service provider. Many types of financial trades include multiple steps and can take a relatively long period of time from their initiation until confirmation and settlement. During this time, a trader may want to determine the status of the various aspects of the trades which have been placed and which may be in various stages of completion.

At present, the capacity to provide this information is limited. This is particularly so for financial service providers, such as those trading international currencies, which have several separate systems that are used at various stages of the transaction, each of which may utilize different databases. For example, a customer may wish to execute several different currency exchanges on various dates, each perhaps having different settlement instructions. Each exchange requires confirmation of a number of separately defined allocations, and the financial service provider may need to contact multiple individuals to confirm financial and settlement details for each allocation. It would be advantageous for a customer to be able to quickly and easily obtain information about all of their pending transactions, including the confirmation status of the trades and various sub-elements of those trades, by issuing a single or a few related queries to a central system.

However, while conventional on-line systems may contain functionality to return some information of this type on-demand in response to queries made by a customer, present systems are limited. One problem is that the information returned to the customer is generally not complete because the information required to fully satisfy the query is distributed throughout the various systems of the financial service provider. As a result, the customer must issue several different queries to various groups or departments of the service provider to gather the desired information. This problem is compounded when the desired data is not directly accessible on-line. A conventional solution to this problem is to provide a central site to which customer queries can be directed. The queries are manually processed and the results returned to the customer. Although this system allows general customer queries to be fully addressed, it is time consuming and inefficient.

It is an object of the present invention to provide a system which provides improved functionality that allows customers to directly monitor the status of one or more trades or other financial transactions.

It is a further object of the invention to provide a system through which a customer can be provided with information about pending trades, which information is obtained from a plurality of separate databases in use by a financial service provider or a related party.

### SUMMARY OF THE INVENTION

These and other objects are addressed by a system which is configured to process customer queries and coordinate access to distributed databases to retrieve the data required to satisfy the query. A particular embodiment is suitable for use by financial service provider to process customer queries regarding the status of various financial transactions. The system has access to a database pool with plurality of data sources in it. Each data source contains a respective type of data. In one embodiment the data pool contains separate data sources for customer reference information, account information, trading information, and trade payment instructions. In order to answer customer queries regarding various transactions, information will typically need to be retrieved from several data sources and the data from those sources combined into a suitable response to the customer query.

According to one aspect of the invention, when a customer query is received, e.g., via an electronic network, the query is analyzed to determine the types of data required to satisfy the query and to break the query into a series of discrete sub-queries. An association table is used to identify the target data sources for each sub-query and the sub-queries are issued to the respective target data sources. The retrieved data is combined and formatted into a form appropriate for the received query, and the data is returned to the issuer of the query.

As will be appreciated, the different data sources may require different query formats. In a particular embodiment, a separate data object is provided for each respective data source or type of data source. Each data manager is configured to issue queries in the appropriate format to the associated data source. Each data manager also has a standard interface to allow upstream system components to treat all data managers equally. A data source manager is provided and configured to receive the query object as input and issue sub-queries to the appropriate data managers. The responses received from the data managers are processed. The data can is preferably aggregated as each sub-query is processed until a response to all outstanding sub-queries has been received.

The query response data can be formatted in a variety of ways prior to being returned to the customer. In one embodiment, a presentation module is provided to act as an interface between the customer and the data request processing modules. The presentation module comprises a plurality of data servlets, each of which is configured to produce an appropriate data query in response to a particular type of data request and receive the responses to the query. The presentation module can further comprise a plurality of server pages, each of which is associated with a respective data servlet. Each server page is configured to receive a response from the associated data servlet and generate a corresponding document, such as an Internet web page, for delivery to the customer, where the generated document includes the respective response.

Advantageously, a system and method according to the present invention allows customer queries which require access to a variety of different data sources to be serviced in an automated manner. This allows, for example, a customer of a financial services provider to directly monitor the status of one or more financial transactions, even when the transactions involve different financial instruments and are being processed by different systems. The system is also modular and easy to configure so that it is relatively simple to add links to additional data sources.

### BRIEF DESCRIPTION OF THE FIGURES

The foregoing and other features of the present invention will be more readily apparent from the following detailed description and drawings of illustrative embodiments of the invention in which:

FIG. 1 is a high level block diagram of a trading environment which incorporates a system according to the invention;

FIG. 2 is a functional diagram of the system;

FIG. 3 is a diagram of the general structure of a JSP module of FIG. 2;

FIG. 4 a diagram of the data source manager environment;

FIG. 5 is a flow diagram illustrating the overall data retrieval process;

FIG. 6 is a flow diagram showing data retrieval process for the data source manager; and

FIGS. 7-10 are sample HTML screens which illustrate the operation of a particular embodiment of the system as seen from the customer's perspective.

### DETAILED DESCRIPTION OF THE PREFERRED EMBODIMENT(S)

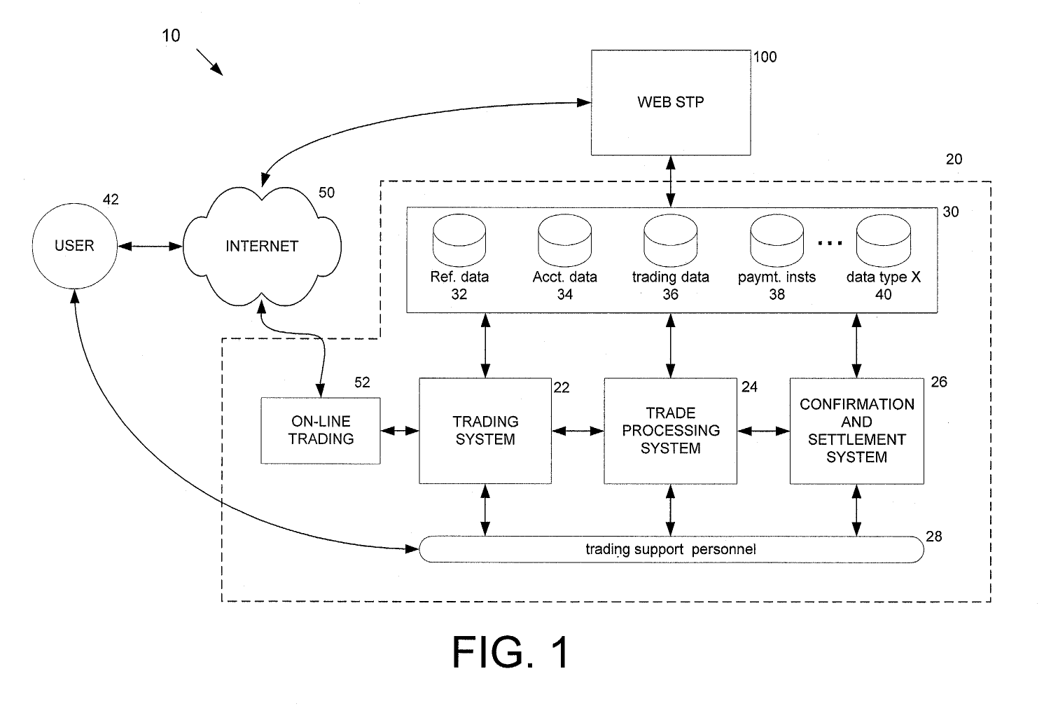

Turning to FIG. 1 there is shown a high level block diagram of a system 10 which incorporates the present invention. The system 10 can be operated by an electronic financial service provider 20. Service provider 20 generally will have different processing systems for implementing various aspects of a financial transaction. In a particular embodiment suited for the exchange of various currencies, provider 20 comprises a trading system 22, a trade processing system 24, and a confirmation and settlement system 26. These systems 22, 24, 26 can be accessed by various trading support personnel 28 typically employees at provider 20.

The various systems 22-26 are used to process financial transactions and store relevant data in a plurality of separate databases. The databases, taken together, can be considered as comprising a database pool 30. In a particular example, separate databases can be provided for reference data 32, account data 34, trading data 36, trade payment instructions 38, as well as various other types of data 40. While there may be some overlap between the data accessed in the database pool 30 by the various systems 22-26, in general, each system is designed to access at most a subset of the total number of databases in the pool 30. As a result, no single system will generally have direct access to all of the data required to provide a complete picture of the status of pending transactions for a given customer.

Trades can be placed with the financial service provider through a number of mechanisms. For example, a customer 42 can directly contact one of the trading support personnel 28 by telephone, facsimile, or other means. In a particular embodiment, service provider 20 further includes an on-line trading module 52 which is connected to a network 50, such as the Internet, through which customers 42 can access the system in order to place trades.

According to one aspect of the invention, a web based, “straight through” processing system 100 referred to herein as (“Web STP”) is provided which is connected between the database pool 30 and the network 50 and which is configured to provide a gateway through which the customer 42 can obtain comprehensive information about one, some, or all of their pending transactions. As discussed more fully below, the Web STP system 100 contains functionality configured to process a customer query, retrieve the appropriate information from the relevant databases in the database pool 30, and deliver the information to the customer, such as in the form of a dynamically generated web page. The system 100 can be implemented in a variety of ways. Preferably, it is implemented as a series of program modules which execute on an application server that is connected to the database pool 30 or a copy thereof. The application server can host one or more of the systems used by the service provider 20 or be a stand-alone system.

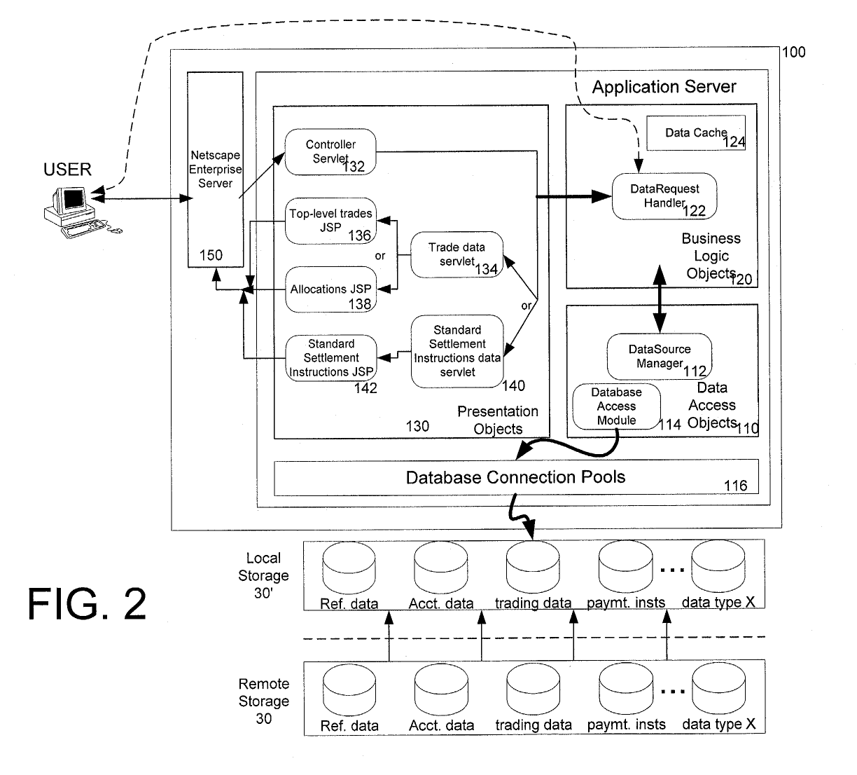

Turning to FIG. 2 there shown a functional diagram of the Web STP system 100. System 100 can be connected directly to the database pool 30. Alternatively, particularly when the databases comprising pool 30 are located in one or more possibly remote locations, the relevant database components can be replicated locally to system 100 to form a local database pool 30′ as shown. Various techniques can be used to replicate the database, such as by use of a conventional Sybase replication tool. System 100 can be directly connected to the database pool 30, 30′. Preferably, however, the connection is made through a suitable firewall (not shown). As will be appreciated, while maintaining a local version of the database pool will speed access to the various database components, system 100 can alternatively be connected to the various remotely located database components using conventional network based technology known to those skilled in the art.

In a preferred implementation, system 100 is comprised of three primary elements—a data access objects module 110, a business logic objects module 120 and a presentation objects module 130. The data access objects module 110 coordinates data access and retrieval from the databases in pool 30′ and is comprised of a data source manager 112 and one or more data access methods 114. The methods 114, which can be static instruction sets, software procedures, active programs or applets, or other variations, are used to process a suitably formatted generic functional data request provided as input and generate one or more derivative requests which are directed to retrieve data from the appropriate database in database pool 30′.

Access to the databases 30′ can be made in a variety of ways. Preferably, the connection is made via a database pool connection 116 which provides a mechanism for sharing a fixed number of connections to a database among different program execution threads. As each thread needs to access a database, it requests a connection from a connection pool manager, performs its database query, and returns the pool to the thread. This system permits efficient handling of concurrent requests from multiple customers while at the same time avoiding the risk of establishing too many connections to the database. The database connection pool 116 is preferably implemented using Web Logic technology known to those of skill in the art. Of course, other methods of providing access to the databases 30′ can alternatively be used.

The business logic object 120 is comprised of a data request handler 122 and may further contain a data cache 124. The data request handler 122 is configured to provide an open interface to process customer initiated data queries and forward them in an appropriate format to the data access objects module 110. Preferably, the data request handler is configured to receive a document, such as an XML document, which represents a data request initiated by customer action (and as may be processed by other portions of system 100). The data request handler parses the input document and, based on its contents, creates a query or request object in a suitable format and forwards that request to the data source manager 112 in the data access object module 110. The data source manager will return one or more data objects in response to the query. These objects are processed and combined by the data request handler 122 as appropriate to the original data request. The data is then converted into a suitable format, such as an XML document, and returned to the requester. Some or all of the retrieved data can be stored in the data cache 124 to simplify future retrieval. The data request handler 122 and the data source manager 112 are discussed in more detail below.

The presentation objects module 130 is comprised of one or more servelets or modules which are responsible for managing input requests from the customer and forwarding the replies containing the appropriate data in a suitable format, such as a HTML document. In a particular embodiment, a controller servelet 132 receives input from the customer and is configured to retrieve a customer's account list from a suitable database (not shown) and validate various request parameters. The controller servelet 132 then forwards the validated request to an appropriate data servelet for subsequent handling in accordance with the type of request, such as the type of data requested. In a preferred embodiment, a trade data servelet 134 and a standard settlement instruction data servelet 140 are provided. If the request is to retrieve data concerning pending trades, such as a summery of all pending transactions, the request is forwarded by the controller servlet 132 to the trade data servelet 134. Similarly, if the request is directed to settlement instructions, the controller servlet 132 forwards it to the standard settlement instructions data servlet 140.

As will be appreciated by those of skill in the art, additional data servlets can also be included in accordance with the types of requests the system 100 is configured to process. Moreover, the division of the request processing functionality into various servlets, such as a trade data and a settlement instruction servlet, is only a preferred implementation and the boundaries between where various functions are implemented can be changed. In an alternative embodiment, the functionality of the various data servlets can be distributed among the other system elements. For example, the functionality of the data servlets can be combined with the controller servlet 132 or a single data servet provided for all types of data requests.

Each data servlet is configured to generate an appropriate request in accordance with customer selection, submit the request to the data request handler 122, and receive the reply containing the requested data. As will be appreciated, the submitted requests should be in a format which is recognized by the data request handler 122. Preferably, requests are formatted as XML documents.

The data servlet then forwards the data received from the data request handler 122 to an appropriate downstream module which converts the (partially processed) data into an HTML document which can then be returned to the customer. There are a variety of ways in which such final formatting can be performed and some embodiments where it may not be necessary. In a preferred embodiment, various Java Server Pages (“JSP”) are provided, each of which is configured to format a particular type of data. JSP technology is used for controlling the content or appearance of Web pages through the use of small programs that are specified in the Web page and run on a Web server to modify the Web page before it is sent to a customer who requested the page. Alternatives, such as formatting pages based upon Microsoft's Active Server Page (“ASP”) technology, can also be used.

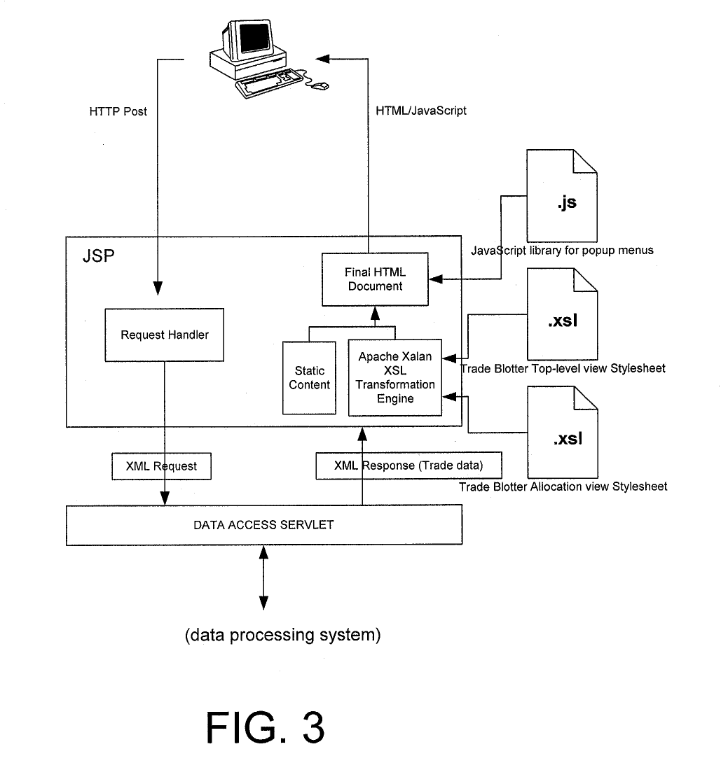

In a particular implementation, three separate JSPs are provided. A top level trades JSP 136 is used to format high-level trading data retrieved via the trade data servlet 134. An allocations JSP 138 is used to process data from the trade data servlet 134 related to allocation details for a given trade. Finally a standard settlement instructions JSP 142 is provided to format data retrieved via the settlement instructions data servlet 140 related to settlement instructions. A diagram illustrating the general structure of a JSP module 136-142 is illustrated in FIG. 3. JSP technology is well known to those of skill in the art and specific implementation details will be apparent from the present description.

As discussed above, the data retrieval components of system 100 center around two primary objects—the Data Request Handler 122 and the Data Source Manager 112. Each of these objects will now be discussed in more detail.

The Data Request Handler 122 is configured to provide an open interface to respond to data queries, such as queries generated by the customer, either directly or via an intermediary data servlet, or from other sources. All data queries in the WebSTP system 100 are preferably handled by the Data Request Handler 122 which accepts an XML document representing a data request as its input and provides an XML document representing the requested data as its response. Upstream functionality, such as the data servlets, are responsible for ensuring that the input data is in the correct format.

The Data Request Handler 122 is configured to parse the input document and create a data request object which is subsequently processed by the Data Source Manager 112. The Data Source Manager will return one or more data objects to the Data Request Handler 122 which then converts the objects into an XML-based format using conventional techniques and returns the objects in the form of an XML document to the requestor.

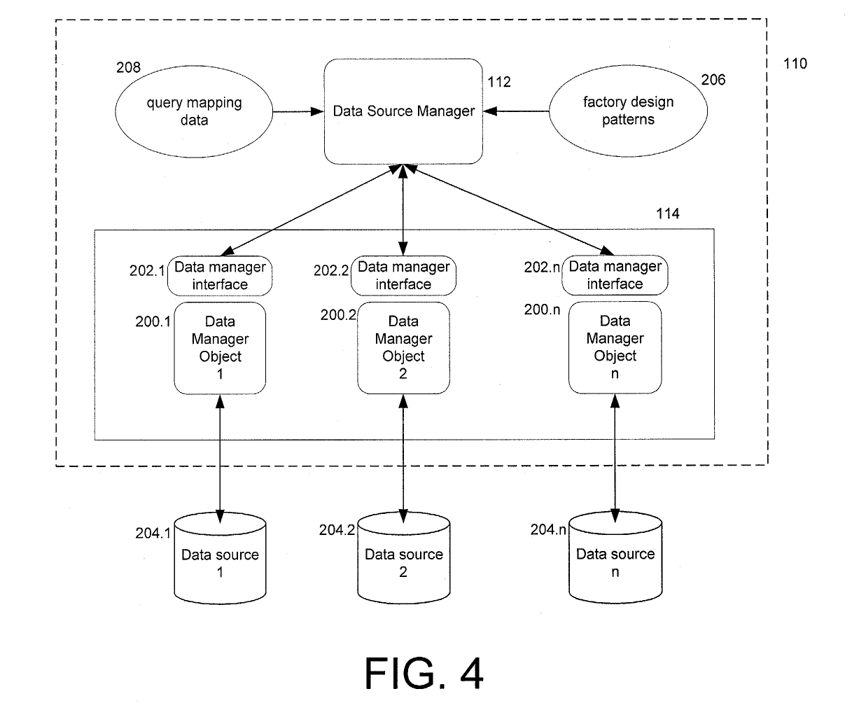

The Data Source Manager 112 is configured to receive a generic functional data request (such as in the form of a pre-defined request object) from the Data Request Handler 122 and translate it into one or more data retrieval queries directed to appropriate data sources in the database pool 30′. In the preferred implementation, and as illustrated in FIG. 4, each separate data source 204.1-204.n, such as the databases in the pool 30′ and possibly data sources outside of the pool 30′, is represented by a corresponding Data Manager object 200.1-200.n. Each data manager object 200.x can preferably be accessed via a standard interface. In the preferred implementation of system 100, the a Java interface syntax is used to define a Data Manager interface 202.x to the Data Manger objects 200.x.

The interface 202.x contains a standard set of generic data retrieval methods which are accessed by the data source manager 112 and which each class (data manger object) representing a data source needs to support. As a result, the Data Source Manager 112 can treat the various Data Manager object classes somewhat anonymously and access them by calling the standard methods in the appropriate interface 200.x without needing to know the precise details of the class it is dealing with or how that class must access the respective data source 204.x.

When the data source manager 112 receives a query which can be satisfied from a single data source, it dispatches the request. If the query will retrieve data from more than one source, the data source manager 112 must determine which class or classes of data manager objects it needs to call upon to get data. This can be done using a factory design pattern 206 which is based on the nature of the request object it receives from the Data Request Handler 124, and by using a set predefined query map structures 208 which maps particular types of requests to the specific class or classes which should be used to process those requests as well as which aspects of the request should be directed to which class. Alternatively, the query map can be generated dynamically or on a periodic basis. A particular implementation of the mapping of a data request object to an appropriate data manager is discussed in more detail below.

Once the mapping is performed, the Data Source Manager 112 dynamically creates an instance of each of the required classes, e.g., by using the factory pattern. Next, the appropriate data retrieval method is executed against each of the objects which were created. Preferably, to optimize performance, the Data Source Manager 112 creates a new execution thread for each of the objects and dispatches the data requests concurrently to each object. As a result, the time for the overall retrieval will equal the time for the slowest data source to return.

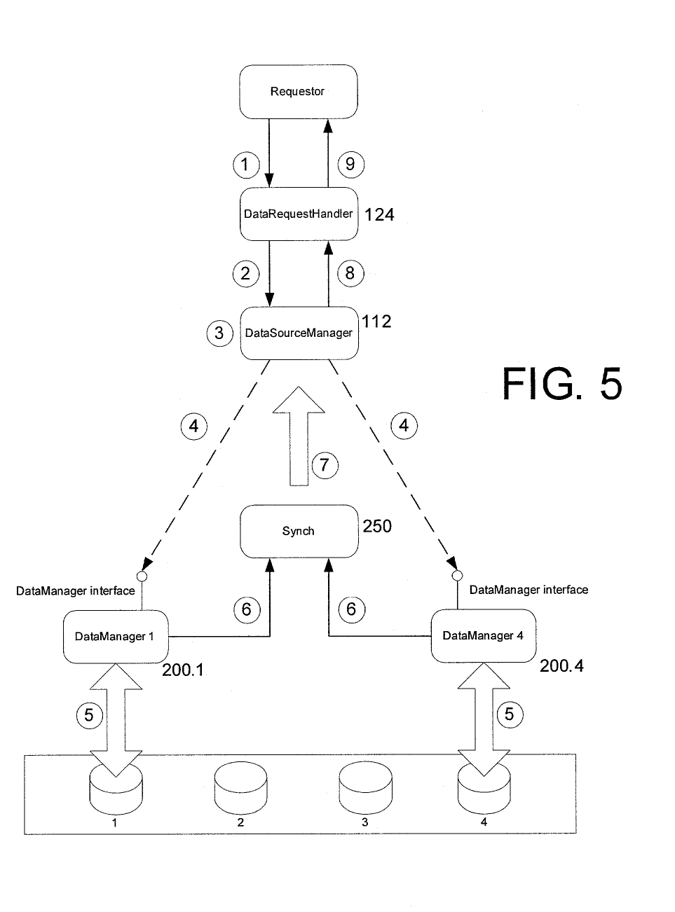

To co-ordinate the completion of each of the data retrieval threads, a synchronization object 250 can be created (see FIG. 5). This object is initialized with information indicating the total number of data sources involved in a current retrieval. As each data source access is completed, the synchronization object is notified and passed the result of the data retrieval. The synchronization object combines the received data, e.g., by concatenating it. Once all of the pending data manager object execution threads have completed, the synchronization object notifies the main request thread that all the work is complete and returns it the overall result set. The Data Source Manager 112 receives this notification and returns the result set as a collection of data objects to the Data Request Handler 124 which then generates an XML document representing the object, which can be returned to the customer as is or formatted into an appropriate HTML document.

As discussed above, in processing a request, a data request object is analyzed to determine the appropriate data managers to which queries must be directed to satisfy the request. When the Data Source Manager 112 receives a data request, the request is analyzed to determine which of the data manager interfaces should be instantiated to handle the request. In a typical implementation, the universe of possible data requests is closed. A set of database tables are provided which can be used to map from an incoming data request to one or more specific requests for data to be directed to particular data managers. In a specific implementation, three data tables are used.

A first table is a Request Key table which contains a list of all defined requests. Each request is assigned a unique ID and has a set of attributes. The attributes include a general request type, such as Get Trade Data or Get Settlement Instructions, and a product type for which the request may apply, such as stock, bond, or Foreign Exchange Option. In some instances, information for a given request and product type may be stored in different databases depending upon, for example, which branch of a financial service provider is servicing a given customer. Accordingly, an Entity attribute can also be provided to specify the various “locations” in which data related to a specific request and product type may be stored.

A received data request object is processed by extracting search keys from the general request information in the data request object which are then used to identify records in the Request Key table that have corresponding attributes. For general requests, the extracted keys can be wildcard values. Thus, for example, a specific request for the status of pending U.S. stock trades may result in only a single matching record while a search using keys from a more general request, such as a request for trade data related to all product types, may return multiple matching entries, such as “get trade data for stocks”, “get trade data for bonds”, etc.

A second table is a Data Manager Class Info table. This provides a mapping of the unique Request Key ID as specified in the Request Key table to the name of the interface to the Data Manager which has access to the data needed to satisfy the request. In one implementation, the interfaces are implemented as Java classes and the table associates Request Key ID values with the Java class implementing the interface to the appropriate Data Manager.

A third table can be provided to store additional information which will be used by a Data Manager handling a request. Typical information stored in such a Data Manager Request Config table can include the name of the database connection pool that should be used by the Data Manager to service the request. Other information can include default configuration information needed by a Data Manager to service a request, such as a password and ID information needed to gain access to a particular database.

When processing an incoming Data Request, the Data Source Manager first extracts the key request attributes from the incoming request and uses these as search criteria to access the Request Key table. As discussed above, the result of the search will be one or more discrete data requests (which will ultimately be used to generate sub-queries that are directed to the various data sources). The Data Manager Class Info table is then accessed using the request IDs for the identified entries to identify the data manager which is to service each discrete data request. Additional configuration information which may be needed by the data manager in order to service the request is retrieved from the Data Manager Request Config table.

Next, for each discrete data request, the Data Source Manager instantiates, calls, or otherwise accesses the appropriate data manager interface and passes it the discrete data request information (e.g., some or all of the attributes of the associated Request Key table entry). It also passes the specific request parameters that are present in the incoming request, such as the customer ID, account numbers, date ranges, trade IDs, and the like. In addition, configuration data retrieved from the Data Manager Request Config table can be provided so that individual Data Manager classes do not need to manage their own configuration data. Each Data Manager is configured to process the received information, which comprises a “generic” discrete data request and specific request parameters provided by the requestor, and generate an appropriate data query. The generated query is then issued to the corresponding data source using the configuration data as required.

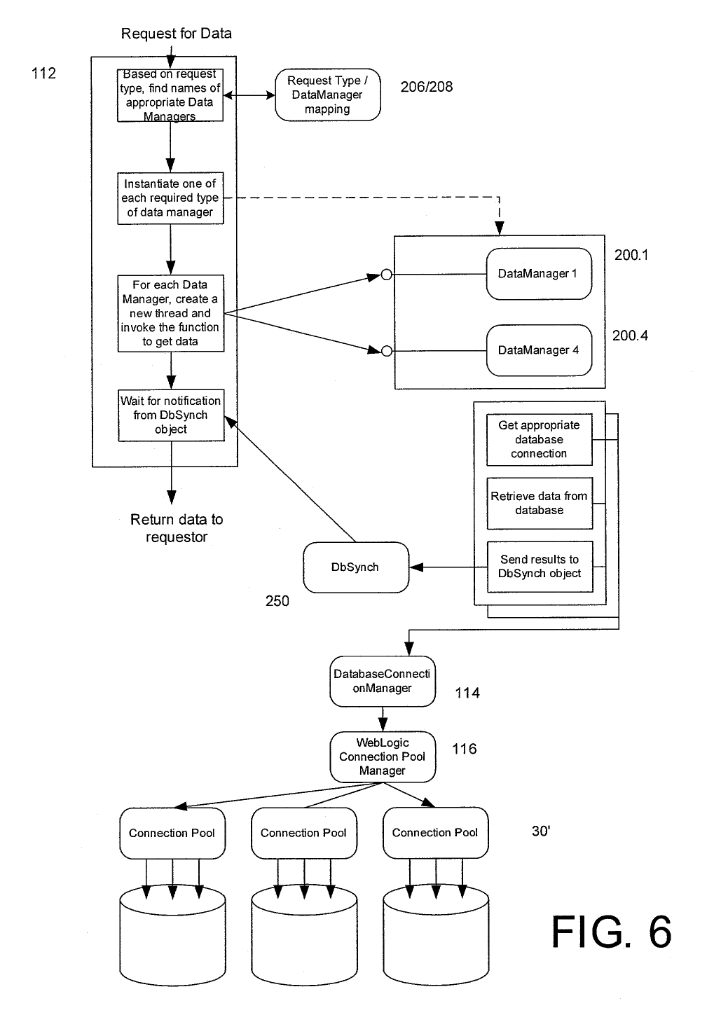

The overall process flow is summarized in FIG. 5. FIG. 6 illustrates the flow in more detail with regard to the data source manager 112. With reference to FIGS. 5 and 6, initially the customer (or other requester) sends an XML query to the Data Request Handler 124 (step 1). Next, the Data Request Handler 124 parses and validates the query, creates an appropriate query object, and forwards it to the Data Source Manager 112. (Step 2). The Data Source Manager 112 then determines which data sources are required to service the query object, e.g., with reference to a request-type data manager mapping. (Step 3). The Data Source Manager (preferably asynchronously) dispatches a request to the appropriate Data manager objects 200.x via the Data Manager interface 202.x. (Step 4). This can be accomplished by instantiating one of each required type of data manager and creating a new program thread which invokes the function to retrieve the data.

The invoked Data Manager objects 200.x connect to the appropriate databases, retrieve data from the databases (step 5), and then notify the synchronization object 250 as they complete (step 6). The synchronization object 250 combines the results and notifies the Data Source Manager 112 when the data manager object requests have completed. (Step 7). The Data Source Manager returns the data objects to the Data Request Handler 124 (step 8) which then translates the data objects into XML and returns the XML object to the Requestor. (Step 9).

The same general process flow can be used to handle a wide variety of data request types made to the system. Advantageously, because the data source manager 112 does not need to address the specifics for each type of data access required, but instead uses a common data manger interface 202.x to access the data manger objects 200.x, it is easy to upgrade the data access module 110 to manage different data types and types of data requests. A new type of request can be implemented by adding that request type to the data source mapping tables, e.g., as defined by the Factory design pattern tables 206. Access to a new data source can be added by creating an appropriate data manager object to access the data source and updating the query mapping data 208 to reference this object as appropriate.

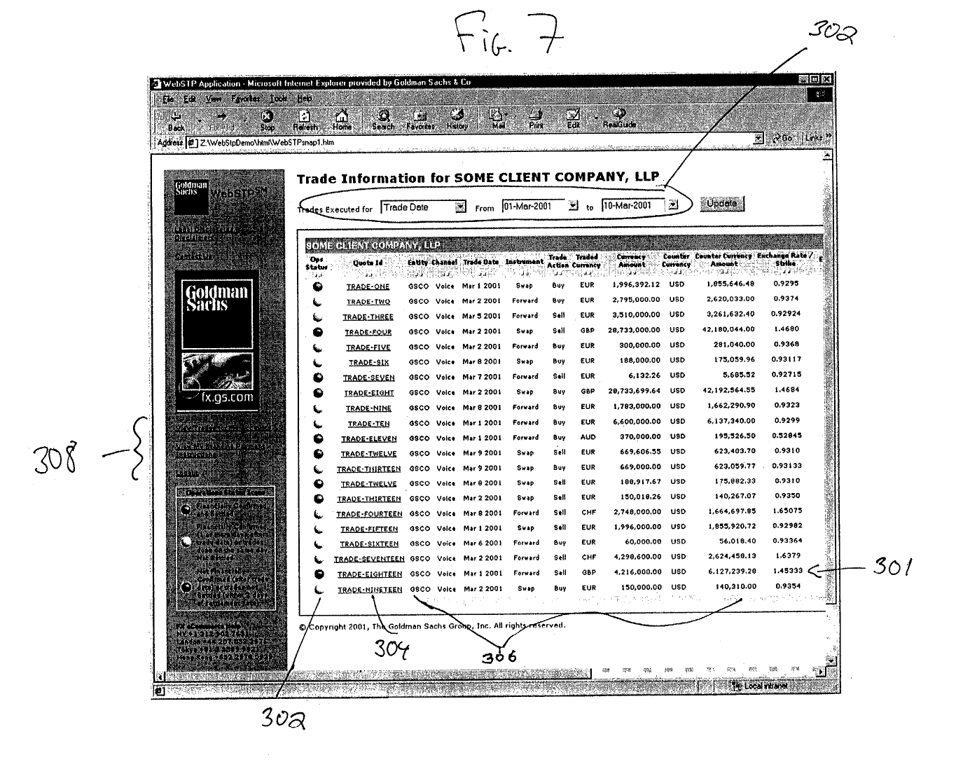

FIGS. 7-10 are sample HTML pages which are generated in a particular implementation of the system 100 and will be used to illustrate the operation of the system as seen from a customer's perspective. Turning to FIG. 7, there is shown a trading information screen for a particular company which lists all trades which fall within a given range of limitations. The customer can select these limitations from an on-screen form 300. Preferably, a default set of limitations are provided. In one embodiment, the trade information is displayed as a table in which each trade is a single row comprising a unique identifier 304 for the trade and a summary of the relevant trade data 306. Depending on the sophistication of the implementation, the customer can be permitted to define the contents of the summary and the order in which the summary data is presented. In addition, a status icon 302 associated with each trade can be displayed and used to indicate, for example by its color, the stage of processing for the given trade and if additional action may be required by the customer.

In practice, when the customer accesses the system 100 (and after suitable logon and verification procedures have been completed), the controller servlet 132 passes the customer's request, e.g., for a trade summary, to the trade data servlet 134 which generates a query based upon the selections made by the customer and possibly other data, such as data retrieved from a customer profile indicating the various accounts the customer is tracking. A sample query generated by the servlet 134 for a customer with four accounts may look like:

<?xml version=“1.0”?>
<DataRequest requestType=“TradeData” >

<TradeQuery>

<DetailLevel>TopLevel</DetailLevel>
<TradeDateRange>

<StartDate>Mar 2 2001</StartDate>
<EndDate>Mar 5 2001</EndDate>

</TradeDateRange>
<Account>33126</Account>
<Account>33130</Account>
<Account>33132</Account>
<Account>33134</Account>

</TradeQuery>

</DataRequest>

The data request handler 122 and Data Source Manager 112 process the request and return an XML document containing the retrieved data from the various data sources for the specified accounts within the given data range and this data is then placed into an HTML document by, e.g., the top-level trades JSP 136 and returned to the customer.

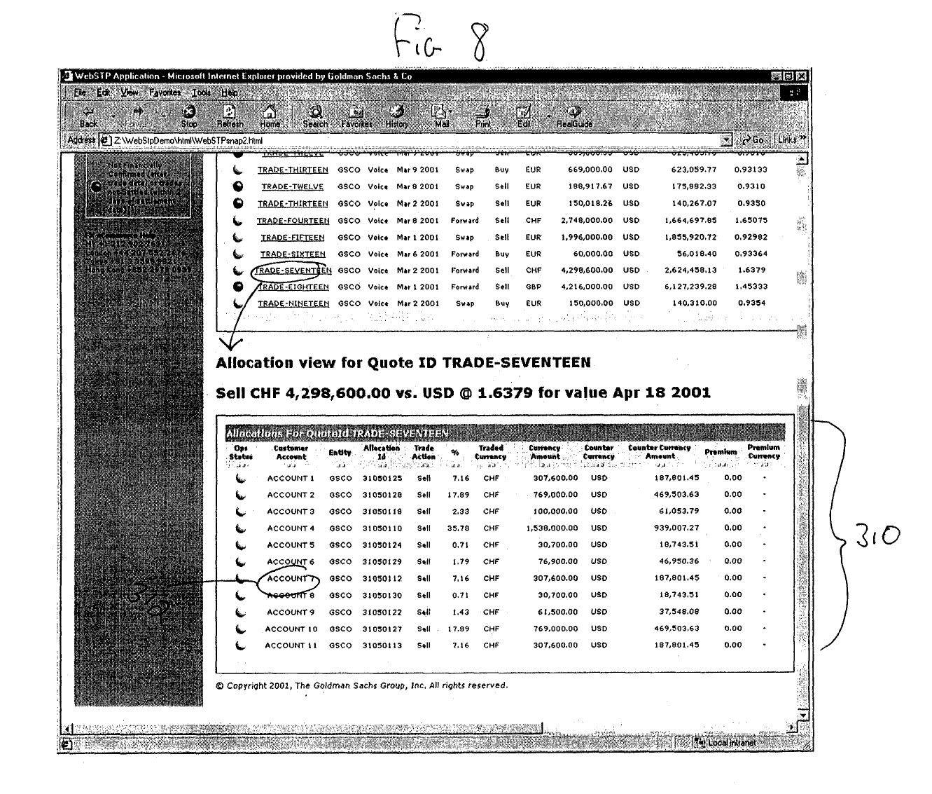

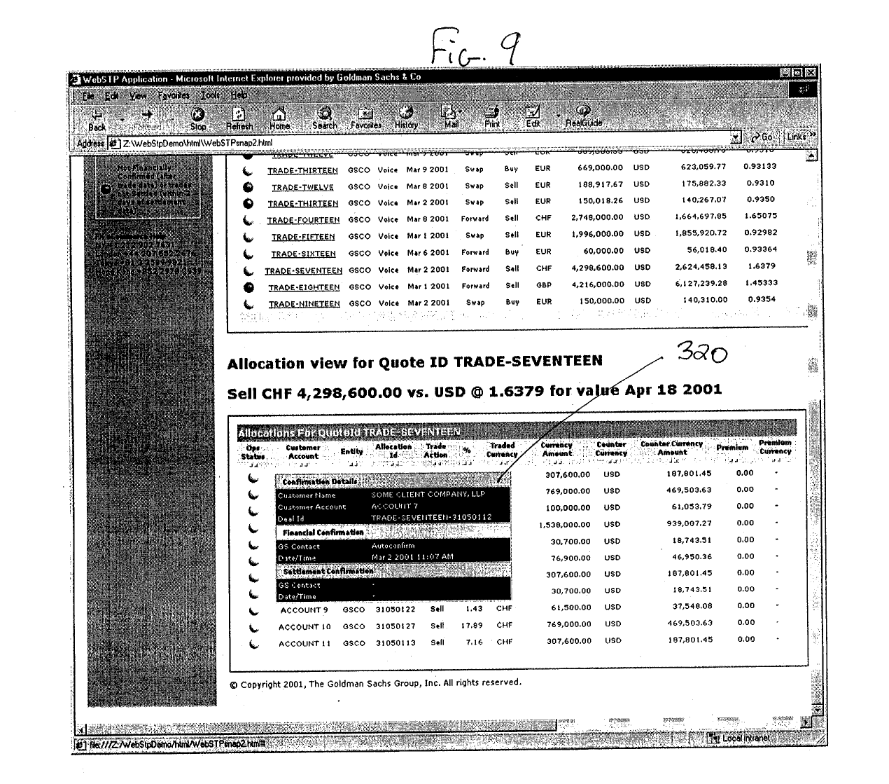

The served page can have active areas which can be selected by the customer to obtain further details. For example, the customer can select (for example, by using a mouse) a unique trade ID to obtain the various allocation details 310 for that trade, such as shown in FIG. 8. When the customer makes such a selection, the controller servlet 132 interprets the selection as a query for further data and processes it as above. (Depending on implementation, various levels of detailed data can be prefetched by the system and maintained in the data cache 124 or in other storage to simplify return of this data to the customer.) Similarly, the allocation view 310 (FIG. 8) can contain further active areas, such as a unique allocation ID 312 which, when selected, can trigger retrieval and display of details regarding the specific confirmations which are required in order to complete the selected allocation, such as shown in FIG. 9, or other information.

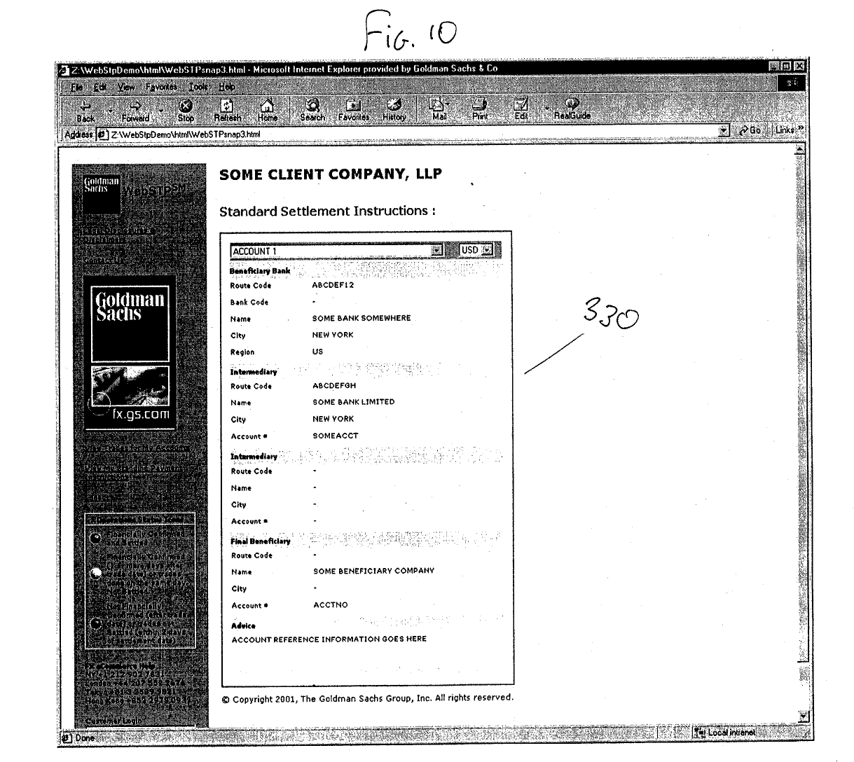

In addition, the various pages can contain links 308 to different types or classes of data retrieval requests. For example, a link to obtain (and possibly modify) standing settlement instructions can be provided. When this link is requested, the controller servlet 132 processes the selection as a query which is directed to the standard settlement instructions data servlet 140 and processed as described above. The returned data can then be displayed in a suitable format, such as table 330 shown in FIG. 10.

The present invention has been described above in terms of preferred embodiments thereof. However, the methods and systems should be considered as examples and various changes in the form and scope of the system can be made without departing from the spirit and scope of the invention. It should be noted that while the term “customer” is used herein with regard to issuing of queries, this term is used for convenience and ease of description only and should not be considered as limiting the invention to satisfying queries only from parties which are customers of the financial services provider. Instead, the invention is suitable for use in satisfying queries from any person, entity or other user, including, but not limited to, clients of the financial service providers and parties acting for them, such as employees of the service provider.

What is claimed is:

1. In a system in communication with a database pool having a plurality of data sources therein, each data source containing information of a respective type, a method of processing user queries to the system comprising the steps of:
receiving a user query via an electronic network;
determining types of data required to satisfy the query;
identifying target data sources from the plurality of data sources that contain information of the determined types;
retrieving data from the target data sources;
combining the retrieved data to generate a response to the query; and
returning the response to the user.

2. The method of claim 1, wherein the step of retrieving data from the identified sources comprises the steps of:
generating a sub-query for each target data source;
issuing the sub-queries to the respective target data sources; and
receiving responses from the respective target data sources for the issued sub-queries.

3. The method of claim 2, wherein:
each data source has a respective data query format;
the sub-queries have a substantially common data query format; and
the step of issuing the sub-queries comprises the step of converting each sub-query from the common data query format to the data query format for the respective target data source.

4. The method of claim 2, further comprising the step of monitoring the status of issued sub-queries;
the step of combining the retrieved data being performed after a response has been received for each issued sub-query.

5. The method of claim 2, wherein each sub-query is issued by a separate processing thread, each processing thread providing a notification when the respective sub-query is satisfied by the corresponding target data source.

6. The method of claim 1, wherein:
the system comprises a financial transaction processing system and
the user queries relate to the status of financial transactions.

7. The method of claim 6, wherein the financial transactions comprise currency exchange transactions.

8. The method of claim 7, wherein the database pool comprises:
a data source for reference information;
a data source for account information;
a data source for trading information; and
a data source for trade payment instruction information.

9. A computer implemented system for processing queries requiring access to a plurality of data sources each of which contains information of a respective type, the system comprising:
a data access module in communication with the plurality of data sources and configured to:
receive a query object in a predefined format as input,
identify a set of target data sources in accordance with a class of the query object,
retrieve data from the target data sources,
aggregate the retrieved data, and
provide the aggregated data as output; and
a data request handler module in communication with the data access module and configured to:
receive a data query as input;
generate the query object in the predefined format from the data query;
provide the query object to the data access module;
receive the aggregated data from the data access module;
process the aggregated data to produce a response to the query; and
provide the response as output.

10. The system of claim 9, further comprising:
a presentation module configured to:
receive via a network a data request from a user as input;
generate a data query in accordance with the data request;
provide the data query to the data request handler module;
receive the response from the data request handler module;
and output the response to the user via the network.

11. The system of claim 10, wherein the presentation module comprises:
a plurality of data servlets, each data servlet configured to produce an appropriate data query in response to a particular type of data request; and
a controller servlet configured to determine the type of the data request and forward the data request to the appropriate data servlet.

12. The system of claim 11, wherein each data servlet is further configured to receive respective responses to forwarded data requests.

13. The system of claim 12, wherein the presentation module further comprises a plurality of server pages, each server page being associated with a respective data servlet and configured to receive the respective response from the associated data servlet and generate a corresponding document including the respective response.

14. The system of claim 13, wherein a particular servlet has a plurality of associated server pages, the particular servlet being configured to provide the respective response to one of the associated server pages in accordance with a data type of the response.

15. The system of claim 13, wherein the document comprises an Internet web page.

16. The system of claim 9, wherein the data access module comprises:
a plurality of data manager objects, each data manager configured to retrieve data from a respective data source;
a storage area having query classification data stored therein; and
a data source manager receiving the query object as input, and configured to:
identify the particular ones of the plurality of data sources from which data should be retrieved in accordance with the query classification data, and
dispatch a respective data retrieval request derived from the query object to the particular data manager objects configured to retrieve data from the identified data sources.

17. The system of claim 16, further comprising a synchronization module configured to aggregate data retrieved from the respective data manager objects.

18. The system of claim 16, wherein each data manager object comprises a respective data manger interface configured to receive data retrieval requests from the data source manager in a common format.

19. The system of claim 16, wherein the classification data comprises query mapping data associating particular types of queries with specific data sources.

20. The system of claim 19, wherein the classification data further comprises query distribution data associating, for a complex query having a plurality parts, particular query parts with particular data sources.

21. The system of claim 9, wherein the data sources containing various information related to financial transactions and the query relates to the status of at least one financial transaction.

22. The system of claim 21, wherein the financial transactions comprise currency exchange transactions.

23. The system of claim 22, wherein the plurality of data sources comprise:
a data source for reference information;
a data source for account information;
a data source for trading information; and
a data source for trade payment instruction information.

24. A method for processing user queries to a financial transaction processing system, data required to satisfy the queries being stored in a database pool having a plurality of data sources therein each containing information of a respective type, the data sources including data sources for reference information, account information, trading information, and trade payment instruction information, the method comprising the steps of:
receiving via an electronic network a user query related to the status of financial transactions managed by the financial transaction processing system;
determining types of data required to satisfy the query;
identifying target data sources from the plurality of data sources that contain information of the determined types;
retrieving data from the target data sources;
combining the retrieved data to generate a response to the query; and
returning the response to the user.

25. The method of claim 24, wherein the step of retrieving data from the identified sources comprises the steps of:
generating a sub-query for each target data source;
issuing the sub-queries to the respective target data sources; and
receiving responses from the respective target data sources for the issued sub-queries.

26. The method of claim 25, wherein:
each data source has a respective data query format;
the sub-queries have a substantially common data query format; and
the step of issuing the sub-queries comprises the step of converting each sub-query from the common data query format to the data query format for the respective target data source.

27. The method of claim 25, further comprising the step of monitoring the status of issued sub-queries;
the step of combining the retrieved data being performed after a response has been received for each issued sub-query.

28. The method of claim 25, wherein each sub-query is issued by a separate processing thread, each processing thread providing a notification when the respective sub-query is satisfied by the corresponding target data source.

29. A computer implemented system for processing queries issued to a financial transaction processing system related to the status of financial transactions, the queries requiring access to a plurality of data sources each containing information of a respective type, the data sources including data sources for reference information, account information, trading information, and trade payment instruction information, the system comprising:
a data access module in communication with the plurality of data sources and configured to:
receive a query object in a predefined format as input,
identify a set of target data sources in accordance with a class of the query object,
retrieve data from the target data sources,
aggregate the retrieved data, and
provide the aggregated data as output; and
a data request handler module in communication with the data access module and configured to:
receive a data query as input;
generate the query object in the predefined format from the data query;
provide the query object to the data access module;
receive the aggregated data from the data access module;
process the aggregated data to produce a response to the query; and
provide the response as output.

30. The system of claim 29, further comprising:
a presentation module configured to:
receive via a network a data request from a user as input;
generate a data query in accordance with the data request;
provide the data query to the data request handler module;
receive the response from the data request handler module;
and output the response to the user via the network.

31. The system of claim 29, wherein the data access module comprises:
a plurality of data manager objects, each data manager configured to retrieve data from a respective data source;
a storage area having query classification data stored therein; and
a data source manager receiving the query object as input, and configured to:
identify the particular ones of the plurality of data sources from which data should be retrieved in accordance with the query classification data, and
dispatch a respective data retrieval request derived from the query object to the particular data manager objects configured to retrieve data from the identified data sources.

32. The system of claim 31, further comprising a synchronization module configured to aggregate data retrieved from the respective data manager objects.

33. The system of claim 31, wherein each data manager object comprises a respective data manger interface configured to receive data retrieval requests from the data source manager in a common format.

34. The system of claim 31, wherein the classification data comprises query mapping data associating particular types of queries with specific data sources.

35. The system of claim 34, wherein the classification data further comprises query distribution data associating, for a complex query having a plurality parts, particular query parts with particular data sources.
